(19) United States
(12) Patent Application Publication
(10) Pub. No.: US 2008/0292979 A1
(43) Pub. Date: Nov. 27, 2008

(54) TRANSPARENT CONDUCTIVE MATERIALS AND COATINGS, METHODS OF PRODUCTION AND USES THEREOF

(76) Inventors: Zhe Ding, Shanghai (CN); James Guiheen, Madison, NJ (US); Peter Smith, Long Valley, NJ (US); HongMin Huang, Shanghai (CN); Ben Palmer, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/751,977

(22) Filed: May 22, 2007

(51) Int. Cl. G03G 15/00; G03G 5/00

(52) U.S. Cl. 430/56; 430/133

(57) ABSTRACT

Transparent conductive materials, articles and films are described herein a) that are easily and efficiently produced, b) can be produced prior to application or in situ, c) are easily applied to surfaces and substrates or formed into articles, d) can be produced and used with materials and methods that are generally accepted by the flat panel display (FPD) industry, along with other industries that produce and utilize microelectronics, e) can be tailored to be photoimageable and patternable using accepted photolithography techniques, f) have superior optical properties and have superior film forming properties, including better adhesion to other adjacent layers, the ability to be laid down in very or ultra thin layers and the ability to remain transparent when laid down as thicker layers. Methods of producing and using these transparent conductive materials are also disclosed.

### FIELD OF THE SUBJECT MATTER

Transparent conductive materials, compounds and compositions for use in various applications are described herein. In addition, films, layers and photosensitive materials comprising these transparent conductive materials, compounds and compositions are also contemplated.

### BACKGROUND

In the production of certain applications in the microelectronics industry, it is necessary and/or useful to have a transparent conductive material or layer. These transparent conductive materials and layers are often utilized to provide electrical connectivity between electrodes. Integrated circuits, interposers, flat panel displays, electro-optic devices, multichip modules, bumping redistribution, passivation stress buffers, and thin film build-up layers on printed circuit boards are examples of applications where having transparent conductive materials and layers, especially patterned ones, are useful and sometimes necessary.

Electrically conductive transparent films are well-known in the patent and scientific literature. Conventional methods of laying down these films on substrates include either dry or wet processes. In dry processes, PVD (including sputtering, ion plating and vacuum deposition) or CVD is used to form a conductive transparent film of a metal oxide, such as indium-tin mixed oxide (ITO), antimony-tin mixed oxide (ATO), fluorine-doped tin oxide (FTO), and aluminum-doped zinc oxide (AI-ZO). The films produced using dry processes have both good transparency and good conductivity. However, these films require complicated apparatus having a vacuum system and has poor productivity. Other problems with dry processes include difficult application results when trying to apply these materials to continuous and/or large substrates. In conventional wet processes, conductive coatings are formed using electrically conductive powders mixed with binders. In all of these conventional methods using metal oxides and mixed oxides, the materials suffer from supply restriction, lack of spectral uniformity and brittleness.

U.S. Pat. No. 5,576,162 also discloses forming electrically conductive layers in conjunction with image-forming layers. The electrically conductive layers utilize carbon nanofibers, but transparency is only achieved by utilizing extremely small diameters of carbon nanofibers in very small amounts. No methods of achieving photosensitivity or patterning of the transparent conducting layer are provided.

US Publication 2004-0099438 discloses patterning carbon nanotubes when combined with a binder resin, however, these films do not appear to be transparent. In addition, there have been publications describing the use of solution processed transparent conductors. For example, Pakbaz (Cambrios) has described the use of solution based methods to make transparent conductors (Venitas-et-Visus, April 2006, and in the 3Q06 USDC FPD Technology Development Report by Display Search, September 2006, p 19).

Cambrios, in US Publication No.: 2007/0074316 (Alden et al.), does not teach conductive layers in which metal nanowires are specifically combined with other conductive particles to form a suitable transparent conductor layer. It would be useful if specific combinations of other materials could be found that would increase the conductivity—transparency performance, improve the “processablity”, and/or improve the flexibility of constituent ingredients for of nanowire-based films. Furthermore, Cambrios specifically teaches that the use of a metal reducing agent can be used as a post-treatment to improve transparent conductor performance. That is, the transparent conductor can be exposed to a chemical that causes silver oxide to be reduced to silver by a reaction such as the following reaction

2Ag₂O+NaBH₄+4H20=4Ag₍ₘ₎+4H₂O+NaB(OH)₄

in half reactions:

2Ag₂O=4Ag⁺+40⁼

4Ag⁺+8e⁼=4Ag

NaBH₄+4H2O=8e⁻+8H⁺+NaB(OH)₄

4O⁼+8H⁺=4H₂O

It would be useful if other treatments could be found which could also increase the conductivity—transparency performance of nanowire-based films. Such alternate treatments would allow substantial raw material and processing flexibility, and could be a method of overall improved product and process performance. Furthermore, many reducing agents are inherently unstable under ambient laboratory conditions. For example, sodium borohydride reacts with ambient water vapor to produce hydrogen gas, and dimethyl aminoborane likewise is a solid which reacts with water to produces hydrogen gas, and thus needs special hazard precautions and shipping. It would be greatly beneficial if other treatments with out these drawbacks could be found.

Also, in US Publication No.: 2007/0074316 (Alden et al.) discloses nanowires-based transparent conductors that can be laid down as a layer and utilized as conductive layers. These nanowires are, in some cases, silver nanowires. Although the conductive layers can be posttreated by a number of processes, such as heat and by reducing agents, there is no indication that the transparent conductive composition can be “pretreated” in such a way as to enhance performance of the formed layer or coating. Alden also discloses the use of photoimaging chemistry in conjunction with transparent coatings containing conductive nanowires. However, there is a need in the art for specific photoimaging chemistries and techniques that are useful specifically for conductive nanowires beyond what has been described in the prior art.

However, there is a need in the art for transparent conductive materials and films that have one or more of the following characteristics: are easily and efficiently produced, can be produced prior to application or in situ, are easily applied to surfaces and substrates, can be produced and used with materials and methods that are generally accepted by the flat panel display (FPD) industry, along with other industries that produce and utilize microelectronics, can be tailored to be photoimageable and patternable using accepted photolithography techniques, have superior optical properties and have superior film forming properties, including better adhesion to other adjacent layers, the ability to be laid down in very or ultra thin layers and the ability to remain transparent when laid down as thicker layers.

### SUMMARY OF THE SUBJECT MATTER

Transparent conductive materials, articles and films are described herein that exhibit one or more of the following characteristics a) are easily and efficiently produced, b) can be produced prior to application or in situ, c) are easily applied to surfaces and substrates or formed into articles, d) can be produced and used with materials and methods that are generally accepted by the flat panel display (FPD) industry, along with other industries that produce and utilize microelectronics, e) can be tailored to be photoimageable and patternable using accepted photolithography techniques, f) have superior optical properties and have superior film forming properties, including better adhesion to other adjacent layers, the ability to be laid down in very thin or ultra thin layers and the ability to remain transparent when laid down as thicker layers.

In other embodiments, transparent conductive materials, articles and layers disclosed herein comprise at least one conductive component, and in some embodiments, at least one photoimageable or photosensitive material.

In some embodiments, transparent conductive materials disclosed include a plurality of conductive nanowires and an alkaline constituent in some embodiments and at least two of the following components: discrete conductive structures, conductive nanowires, conductive nanoparticles, conductive nanotubes, conducting polymers and composites, or combinations thereof in other embodiments.

Methods of forming patterned transparent conductive coatings include: a) providing and applying a layer comprising at least one photosensitive or photoimageable composition to a surface; b) providing and applying the transparent conductive materials disclosed to the previously applied layer, and c) exposing and developing the layered material to form a patterned transparent conductive coating. In other embodiments, methods of forming patterned transparent conductive coatings include: a) providing and applying the transparent conductive materials disclosed to a surface; b) providing and applying a layer comprising at least one photosensitive or photoimageable composition to the previously applied layer, and c) exposing and developing the layered material to form a patterned transparent conductive coating. In yet other embodiments methods of forming a patterned transparent conductive coating include: a) providing and applying a layer comprising materials disclosed, and exposing and developing the layer to form a patterned transparent conductive coating. In some embodiments, these coatings are treated with at least one finishing step.

### BRIEF DESCRIPTION OF THE FIGURES

FIG. 1 shows how DNQ compounds generate carboxylic groups, which are then soluble in TMAH.

FIG. 2 shows a contemplated acrylic graft with carbon nanotubes (CNT).

FIG. 3 shows representative transparency and sheet resistance data from coatings made with silver nanowire suspensions and suspensions combining silver nanowires (AgNW) with carbon nanotubes (CNT).

Table 1 provides some properties and goals for contemplated layered materials.

### DETAILED DESCRIPTION

Transparent conductive materials, articles and films are described herein that exhibit one or more of the following characteristics: a) are easily and efficiently produced, b) can be produced prior to application or in situ, c) are easily applied to surfaces and substrates or formed into articles, d) can be produced and used with materials and methods that are generally accepted by the flat panel display (FPD) industry, along with other industries that produce and utilize microelectronics, e) can be tailored to be photoimageable and patternable using accepted photolithography techniques, f) have superior optical properties and have superior film forming properties, including better adhesion to other adjacent layers, the ability to be laid down in very thin or ultra thin layers and the ability to remain transparent when laid down as thicker layers.

Specifically, transparent conductive materials, articles and layers disclosed herein comprise a plurality of conductive nanowires and at least one alkaline constituent, in some embodiments, at least one or two conductive components and, in other embodiments, at least one photoimageable or photosensitive material. In some embodiments, the transparent conductive material may additionally comprise a binder material that is not considered to be photoimageable or photosensitive, but is purely utilized to suspend or spread the conductive materials. Methods of producing the transparent conductive materials, with and without the at least one photoimageable or photosensitive material, are also disclosed herein. These novel methods correct many of the previously described problems of the prior art.

Contemplated conductive components are those materials that are capable of conducting electrons, such as discrete conductive structures, conductive nanowires, conductive nanoparticles, including metal and metal oxide nanoparticles, conductive nanotubes and conducting polymers and composites. These conductive components may comprise metal, metal oxide, polymers, alloys, composites, carbon or combinations thereof, as long as the component is sufficiently conductive.

One example of a conductive component is a discrete conductive structure, such as a metal nanowire, which comprises one or a combination of transition metals, such as silver, nickel, tantalum or titanium, as shown in Examples 2 and 3 herein. As used herein, the term “metal” means those elements that are in the d-block and f-block of the Periodic Chart of the Elements, along with those elements that have metal-like properties, such as silicon and germanium. As used herein, the phrase “d-block” means those elements that have electrons occupying the 3d, 4d, 5d, and 6d orbitals surrounding the nucleus of the element. As used herein, the phrase “f-block” means those elements that have electrons occupying the 4f and 5f orbitals surrounding the nucleus of the element, including the lanthanides and the actinides.

Other conductive components include multiwalled or singlewalled conductive nanotubes, such as those described in the prior art. These nanotubes may comprise carbon, metal, metal oxide, conducting polymers or a combination thereof. Some contemplated nanotubes may comprise those produced by utilizing the disclosure in US Application entitled “Transparent Conductors, Methods of Production and Uses Thereof”, which is commonly-owned and incorporated herein in its entirety by reference.

Additionally, it is contemplated that the at least one or two conductive components may be selected and included based on a particular diameter, shape, aspect ratio or combination thereof. For example, nanowires and/or nanotubes may be specifically chosen to have at least a bimodal distribution, such that larger or longer components represent the “conductivity highway” and the smaller or shorter components ensure “connectivity”. As used herein, the phrase “aspect ratio” designates that ratio which characterizes the average particle size divided by the average particle thickness. In some embodiments, conductive components contemplated herein have a high aspect ratio, such as at least 100:1. In other embodiments, the aspect ratio is at least 300:1. A 100:1 aspect ratio may be calculated—in one embodiment—by utilizing components that are 6 microns by 600 Angstroms (wherein one micron 10,000 Angstroms).

Along with the conductive component, transparent conductive materials contemplated herein may comprise at least one photoimageable or photosensitive material. As will be discussed, the at least one photoimageable or photosensitive material may be added as a separate and independent component of the transparent conductive material or may be specifically grafted or coupled to the conductive component to form the transparent conductive material.

These photoimageable or photosensitive materials may comprise photoacid generators (PAG), photobase generators (PBG), free radical generators, polymeric or monomeric-based photoimageable materials, such as those described in PCT Application Serial No.: PCT/CN2006/001351 entitled “Photosensitive Materials and Uses Thereof”¹ and filed on Jun. 30, 2006, which is commonly-owned by Honeywell International Inc. and incorporated herein in its entirety by reference.

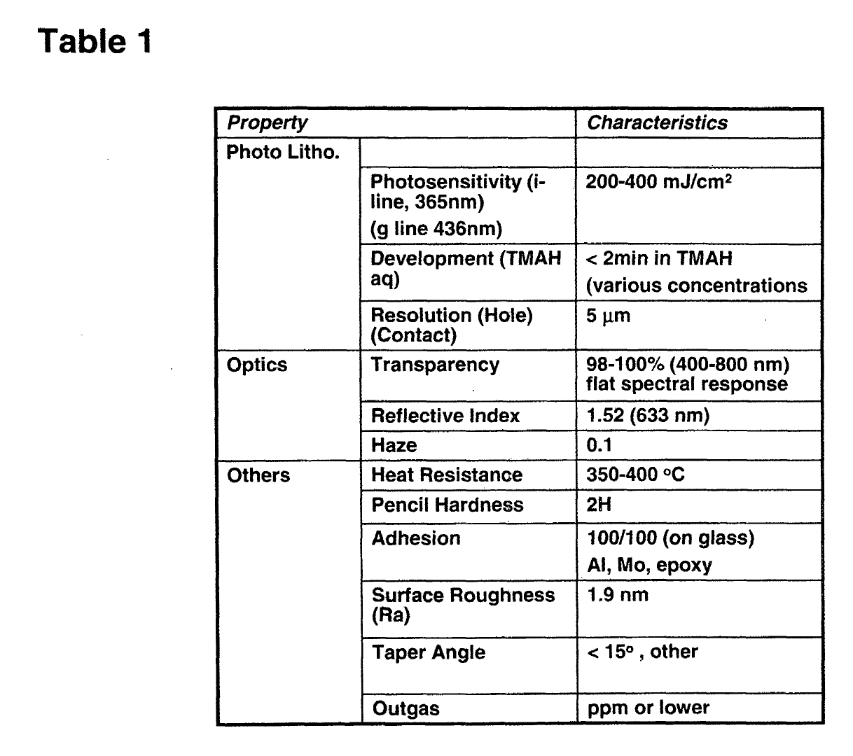

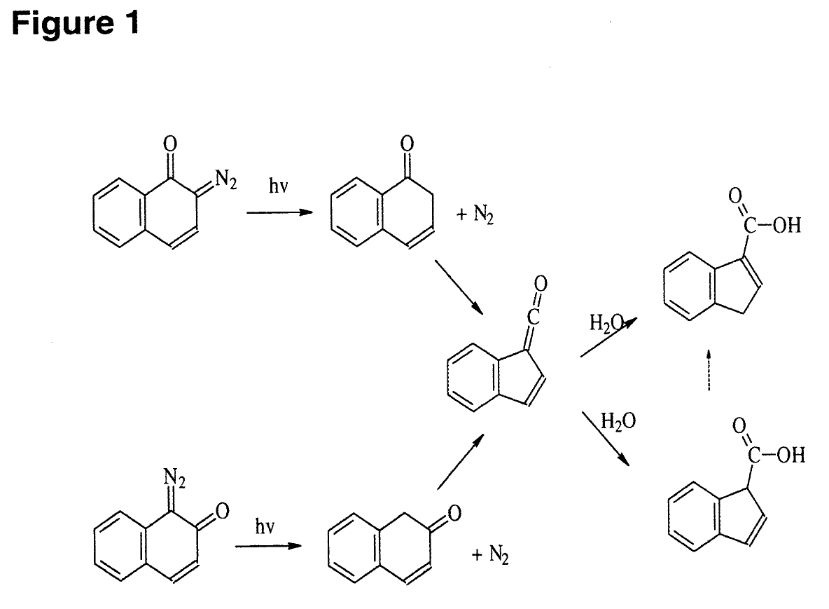

Quinones, such diazonaphthoquinone (DNQ), are “positive type” photoimagers and are commonly used in photoresists. DNQ absorbs strongly from approximately 300 nm to 450 nm. After exposure to light, these compounds generate carboxylic groups, which are soluble in TMAH (FIG. 1). This TMAH solubility is important when, for example, DNQ is mixed with carbon nanotubes, since these nanotubes are also soluble in TMAH. DNQ also has the added benefit of functioning as a dissolution inhibitor and can be formulated to be active in i-line (200 mJ/cm²). As used herein, “i-line” or “i-line radiation” is that radiation at 365 nm wavelengths, and in this case, a component which is “active in i-line” means that it is active when exposed to 365 nm wavelength UV radiation.

Photoacid and photobase generators may also be utilized as photoimageable or photosensitive materials. Compositions described herein may comprise at least one photoinitiator, which is designed to generate free radicals. Contemplated photoinitiators comprise both Type I and Type II photoinitiators. The phrase “Type I photoinitiators” as used herein means that those photoinitiators undergo a unimolecular bond cleavage reaction upon irradiation thereby yielding free radicals. Suitable Type I photoinitiators comprise benzoin ethers, benzyl ketals, α-dialkoxy-acetophenones. α-hydroxyalkylphenones and acyl-phosphine oxides. The phrase “Type II photoinitiators” as used herein means that those photoinitiators undergo a bimolecular reaction where the photoinitiators interact in an excited state with a second compound acting as co-initiators, Suitable type II photoinitiators comprise benzophenones, thioxanthones and titanocenes. Suitable co-initiators comprise amine-functional monomers, oligomers or polymers. Primary, secondary and tertiary amines can be utilized. In some contemplated embodiments, tertiary amines are utilized in the compositions described herein.

Both Type I and Type II photoinitiators are commercially available, for example, as IRGACURE™ 184 (1-hydroxycyclohexyl phenyl ketone), IRGACURE™ 907 (2-methyl-1-[4-(methylthio)phenyl]-2-morpholino propan-1-one), IRGACURE™ 369 (2-benzyl-2-N,N-dimethylamino-1-(4-morpholinophenyl)-1-butanone), IRGACURE™ 819 (bis(2,4,6-trimethylbenzoyl)-phenylphosphineoxide), IRGACURE™ 500 (the combination of 50% by weight 1-hydroxy cyclohexyl phenyl ketone and 50% by weight benzophenone), Irgacure 651 (2,2-dimethoxy-2-phenyl acetophenone), IRGACURE™ 1700 (the combination of 25% by weight bis(2,6-dimethoxybenzoyl-2,4,4-trimethyl pentyl) phosphine oxide, and 75% by weight 2-hydroxy-2-methyl-1-phenyl-propan-1-one), IRGACURE™ 1800 (25% Bis(2,6-dimethoxybenzoyl)-2,4,4-trimethyl-1 pentylphosphineoxide and 75% 1-hydroxy-cyclohexyl-phenyl-ketone), IRGACURE™ 379 (2-Dimethylamino-2-(4-methyl-benzyl)-(4-morpholin-4-yl-phenyl)-butan-1-one), IRGACURE™ 2959(1-[4-(2-Hydroxyethoxy)-phenyl]-2-hydroxy-2-methyl-1-propane-1-one), IRGACURE™ 127(2-Hydroxy-1-{4-[4-(2-hydroxy-2-methyl-propionyl)-benzyl]-phenyl}-2-methyl-propan-1-one), IRGACURE™ 784(Bis(.eta. 5-2,4-cyclopentadien-1-yl)-bis(2,6-difluoro-3-(1H-pyrrol-1-yl)-phenyl) titanium), IRGACURE™ OXE01(1,2-Octanedione, 1-[4-(phenylthio)phenyl]-2-(O-benzoyloxime)), IRGACURE™ OXE02(Ethanone, 1-[9-ethyl-6-(2-methylbenzoyl)-9H-carbazol-3-yl]-, 1-(Oacetyloxime)), DAROCUR™ ITX (2-Isopropylthioxanthone), DAROCUR™ 1173 (2-hydroxy-2-methyl-1-phenyl-1-propanone) and DAROCUR™ 4265 (the combination of 50% by weight 2,4,6-trimethylbenzoyldiphenyl-phosphine oxide, and 50% by weight 2-hydroxy 2-methyl-1-phenyl-propan-1-one), from Ciba-Geigy Corp., Tarrytown, N.Y.; ESACURE™ KIP 100 and ESACURE™ TZT from Lamberti Spa, Gallarate, Italy; 2- or 3-methylbenzophenone from Aldrich Co., Milwaukee, Wis., U.S.A. or GENOCURE™ CQ, GENOCURE™ BOK, and GENOCURE™ M. F., from Rahn Radiation Curing, Combinations of these materials may also be utilized herein.

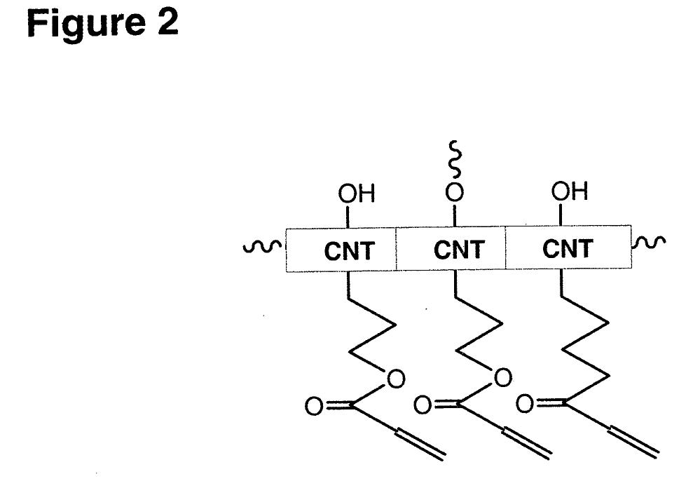

In addition, these conductive components may comprise grafted or extended segments that are designed to link and/or crosslink the conductive components into lines, layers or webs. For example, acrylic resins can be grafted onto the carbon nanotubes and nanowires in order to link and crosslink the conductive components. In addition, these resins may have the added benefit of adding a photoimageable or photosensitive material to the conductive components. FIG. 2 shows a contemplated acrylic graft with carbon nanotubes (CNT).

Contemplated photoimageable and/or photosensitive materials are made from and/or comprise at least one monomeric compound, polymeric compound or a combination thereof. The monomeric compounds and polymeric compounds are also contemplated to be crosslinkable. In some embodiments, contemplated monomeric compounds and polymeric compounds should have at least two reactive groups that can be hydrolyzed. These reactive groups include those groups that can be hydrolyzed, such as alkoxy (RO), acetoxy (AcO), etc. Without being bound by any hypothesis, it is believed that water hydrolyzes the reactive groups on the silicon-based monomeric compounds and polymeric compounds to form Si—OH groups (silanols). These silanol groups will then undergo condensation reactions (crosslinking) with other silanols or with other reactive groups, as illustrated by the following formulas:

Si—OH+HO—Si→Si—O—Si+H2O

Si—OH+RO—Si→Si—O—Si+ROH

Si—OH+AcO—Si→Si—O—Si+AcOH

Si—OAc+AcO—Si→Si—Si+Ac₂O

where:
R comprises alkyl or aryl groups, and Ac means “acyl”, which is represented as CH₃CO.

These contemplated condensation reactions lead to formation of silicon-containing polymeric compounds. In one embodiment, the at least one monomeric compound includes at least one compound denoted by Formula 1.

RₓF_{y}—Si-L_{z} (Formula II

wherein x is in the range from 0 to 3, y is in the range from 0 to 3, and z is in the range from 1 to 4,
R comprises alkyl, aryl, hydrogen, alkylene, arylene groups or combinations thereof,
F comprises at least one alkyl group, wherein the at least one alkyl group either comprises at least one unsaturated bond or is terminally combined with at least one unsaturated functional group, such as:
a) a vinyl group

H₂C═CH—,

b) a (meth)acryl group (where R₀ is H, or CH₃, or other alkyl group):

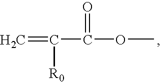

c) N-vinylpyrrolidone group

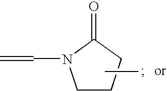

d) dihydropyrandone group

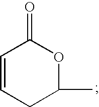

L comprises at least one electronegative group, such as a hydroxyl group, an alkoxy group, a carboxyl group, an amino group, an amido group, a halide group, an isocyanato group or a combination thereof.

An example of a contemplated monomeric compound is shown by Formula 1 when x is less than 3, y is less than 3, z is in the range of 1 to 4; R comprises alkyl, aryl or H; F is unsaturated and L comprises an electronegative group. Additional examples of suitable compounds comprise:
Si(OCH₂CH₃)₄ tetrakisethoxysilane,
Si(OCH₃)₄ tetrakismethoxysilane,
Si(OCH₂CF₃)₄ tetrakis(2,2,2-trifluoroethoxy)silane,
Si(OCOCF₃)₄ tetrakis(trifluoroacetoxy)silane,
Si(OCN)₄ tetraisocyanatosilane,
CH₃Si(OCH₂CH₃)₃ tris(ethoxy)methylsilane,
CH₃Si(OCH₂CF₃)₃ tris(2,2,2-trifluoroethoxy)methylsilane,
CH₃Si(OCOCF₃)₃ tris(trifluoroacetoxy)methylsitane*,
CH₃Si(OCN)₃ methyltriisocyanatosilane,
CH₃CH₂Si(OCH₂CH₃)₃ tris(ethoxy)ethylsilane,
CH₂═CH(CH₃)COOCH₂CH₂CH₂SiCH₃(OCH₃)₂ 3-methacryloxypropylmethyldimethoxysilane
CH₂═CH(CH₃)COOCH₂CH₂CH₂Si(OCH₃)₃ 3-methacryloxypropyltrimethoxysilane
CH₂═CH(CH₃)COOCH₂CH₂CH₂Si(OCH₃)₃ 3-methacryloxypropylmethyldiethoxysilane
CH₂═CH(CH₃)COOCH₂CH₂CH₂Si(OCH₂CH)₃ 3-methacryloxypropyltriethoxysilane
CH₃(CH₃)COOCH₂CH₂CH₂Si(OCH₂CH₃)₃ 3-acryloxypropyltrimethoxysilane
CH₂═CHSi(OCH₂CH₃)₃ Vinyltriethoxysilane
CH₂═CHSi(OCH₃)₃ Vinyltrimethoxysilane
CH₂═CHSiCl₃ Vinyltrichlorosilane
PhCH═CHCOOCH₂CH₂CH₂Si(OCH₂CH₃)₃ 3-(triethoxysilyl)propyl cinnamate
   * generates an acid catalyst upon exposure to water,

Combinations of the above-mentioned monomeric compounds may also be utilized in the compositions to form the films disclosed herein. In addition, methacryloxy(alkyl)ₙalkoxysilane may also be utilized in the compositions and films disclosed herein, where n is 1-100. It should be understood that for these compounds having more than one alkyl group in the compound that the alkyl or alkoxy group may be the same or different. For example, 3-methacryloxypropylmethyldimethoxysilane is contemplated, along with 3-methacryloxypropyltrimethoxysilane, 3-methacryloxyalkyltriethoxysilane and 3-methacryloxyalkyltrimethoxysilane.

In another embodiment, compositions contemplated herein include a polymeric compound synthesized using those compounds denoted by Formula 1, and reacting those compounds together, such as by hydrolysis and condensation, wherein the number average molecular weight (MWₙ) is less than about 300,000. In some embodiments, MWₙ is in the range of about 150 to about 300,000 amu, and in other embodiments, MWₙ is in the range of about 150 to about 10,000 amu.

In other embodiments, silicon-based monomeric compounds may also comprise organosilanes, including, for example, alkoxysilanes according to Formula 2:

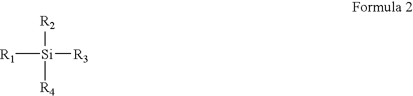

Formula 2 is a variation of Formula 1, where x and y are zero. In this embodiment, Formula 2 represents an alkoxysilane wherein R₁, R₂, R₃, and R₄ groups are independently C1 to C4 alkoxy groups, and the balance, if any, comprise hydrogen, alkyl, phenyl, halogen, substituted phenyl or a combination thereof. As used herein, the term “alkoxy” includes any other organic groups which can be readily cleaved from silicon at temperatures near room temperature by hydrolysis. In Formula 2, Rₓ (x=1, 2, 3, 4) groups may comprise ethylene glycoxy, propylene glycoxy or the like, and in some contemplated embodiments, all four Rₓ (x=1, 2, 3, 4) groups comprise methoxy, ethoxy, propoxy or butoxy. In yet other embodiments, alkoxysilanes according to Formula 2 comprise tetraethoxysilane (TEOS) and tetramethoxysilane.

In additional embodiments, contemplated monomeric compounds may also comprise alkylalkoxysilane as described by Formula 2, where at least two of the R groups are independently C1 to C4 alkylalkoxy groups, wherein the alkyl moiety is C1 to C4 alkyl and the alkoxy moiety is C1 to C6 alkoxy, or ether-alkoxy groups; and the balance, if any, comprise hydrogen, alkyl, phenyl, halogen, substituted phenyl or combinations thereof. In one embodiment, each Rₓ comprises methoxy, ethoxy or propoxy. In another embodiment, at least two R^{x} groups are alkylalkoxy groups, wherein the alkyl moiety is C1 to C4 alkyl and the alkoxy moiety is C1 to C6 alkoxy. In yet another embodiment for a vapor phase precursor, at least two Rₓ groups are ether-alkoxy groups of the formula (C1 to C6 alkoxy)ᵣ wherein n is 2 to 6.

Contemplated silicon-based monomeric compounds include, for example, at least one alkoxysitane, such as tetraethoxysilane, tetrapropoxysilane, tetraisopropoxysilane, tetra(methoxyethoxy)silane, tetra(methoxyethoxyethoxy)silane, all of which have four groups which may be hydrolyzed and then condensed to produce alkylalkoxysitanes, such as methyltriethoxysitane silane and arylalkoxysilanes, such as phenyltriethoxysilane and polymer precursors, such as triethoxysilane, all of which provide Si—H functionality to the film. Tetrakis(methoxyethoxyethoxy)silane, tetrakisalkoxysilane, tris(trifluoroacetoxy)alkylsilane, alkyltriisocyanatosilane tetrakis(ethoxyethoxy)silane, tetrakis(butoxyethoxyethoxy)silane, 3-acryloxyalkyltrimethoxysilane tetrakis(2-ethylthoxy)silane, tetrakis(methoxyethoxy)silane, vinyltrialkoxysilane and tetrakis(methoxypropoxy)silane are contemplated as also being useful in the compositions and films described herein alone or in combinations with other monomeric compounds and/or polymeric compounds.

In other embodiments, monomeric compounds comprise acetoxysilane, ethoxysilane, methoxysilane or combinations thereof. In some embodiments, the monomeric compound includes a tetra acetoxysilane, a C1 to about C6 alkyl or aryl-triacetoxysilane or combinations thereof. In other embodiments, the monomeric compound comprises triacetoxysilane, such as methyltriacetoxysilane. In yet other embodiments, the monomeric compound comprises at least one tetraalkoxysilane and one silicon-based acryl group. In yet another embodiment, the monomeric compound comprises at least one tetraalkoxysilane, one alkylalkoxysilane and one silicon-based acryl group.

Photosensitive and/or photoimageable materials described herein may comprise a polymeric compound that is formed from the monomeric compound as denoted by Formula 1 and/or Formula 2, through reactions such as hydrolysis and condensation. In some embodiment, the number average molecular weight (MWₙ) of such polymeric compound is less than about 1,000,000. In some embodiments, MWₙ is in the range of about 150 to about 100,000 amu, and in other embodiments, MWₙ is in the range of about 500 to about 10,000 amu. The typical structure of contemplated polymeric compounds formed from monomeric compounds described herein is shown by Formula 3:

(RₓSiO_{2-x/2})ₙ(F_{y}SiO_{2-y/2})_{b}(L_{z}SiO_{2-z/2})_{c} Formula 3

wherein x is ranging from 0 to 4, y is from 0 to 4, z is from 0 to 4, a is from 0 to 10,000, b is from 0 to 10,000, and c is from 0 to 10,000; R comprises alkyl, aryl, hydrogen, alkylene, arylene groups, or combinations thereof; F comprises at least one alkyl group, which is capped with and incorporated with at least one unsaturated functional group, such as vinyl group, (meth)acryl group, N-vinylpyrrolidone group, dihydropyrandone group, or combinations thereof; and L comprises an electronegative group, such as an hydroxyl group, an alkoxy group, a carboxyl group, an amino group, an amido group, a halide group, an isocyanato group or combinations thereof.

Compositions contemplated herein may also comprise polymerization inhibitors, or light stabilizers. These material are utilized in varying amounts in accordance with the particular use or application desired. When included, their amounts will be sufficient to provide increased storage stability yet still obtain adequate photosensitivity for the composition, Suitable inhibitors include benzoquinone, naphthoquinone, hydroquinone derivatives and mixtures thereof. Suitable light stabilizers include hydroxybenzophenones; benzotriazoles; cyanoacrylates; triazines; oxanilides derivatives; poly(ethylene naphthalate); hindered amines; formamidines; cinnamates; malonate derivatives and combinations thereof.

As mentioned, some contemplated embodiments of transparent conductive materials, articles and layers disclosed herein comprise at least one or two conductive components and at least one photoimageable or photosensitive material. In some instances these materials, compositions/components, articles and/or layers may be irradiated, wherein the irradiation facilitates the photosensitive or photoimageable material to decompose. This decomposed product can be removed by a developing solution in order to produce a pattern or produce a more finished material, composition/component, article and/or layer. These materials, compositions/components, articles and/or layers may be irradiated by any suitable source or method, including infrared, UV/VIS, laser sources or a combination thereof.

Contemplated transparent conductive materials and compositions may optionally include at least one solvent. Contemplated solvents include any suitable pure or mixture of molecules that are volatilized at a desired temperature, such as the critical temperature, or that can facilitate any of the above-mentioned design goals or needs. The solvent may also comprise any suitable pure or mixture of polar and non-polar compounds. As used herein, the term “pure” means that component that has a constant composition. For example, pure water is composed solely of H₂O, As used herein, the term “mixture” means that component that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound. A solvent may be optionally included in the composition to lower its viscosity and promote uniform coating onto a substrate by art-standard methods.

Contemplated solvents are those which are easily removed within the context of the applications disclosed herein. For example, contemplated solvents comprise relatively low boiling points as compared to the boiling point of the precursor components. In some embodiments, contemplated solvents have a boiling point of less than about 250° C. In other embodiments, contemplated solvents have a boiling point in the range from about 50° C. to about 250° C., in order to allow the solvent to evaporate from the applied film and leave the active portion of the photosensitive composition in place. In order to meet various safety and environmental requirements, the at least one solvent has a high flash point (generally greater than about 40° C.) and relatively low levels of toxicity.

Suitable solvents comprise any single or mixture of organic, organometallic, or inorganic molecules that are volatized at a desired temperature. In some contemplated embodiments, the solvent or solvent mixture (comprising at least two solvents) comprises those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosine, isobutylbenzene, methylnaphthalene, ethyltoluene, ligroine.

In other contemplated embodiments, the solvent or solvent mixture may comprise those solvents that are not considered part of the hydrocarbon solvent family of compounds, such as ketones, such as acetone, diethyl ketone, methyl ethyl ketone and the like, alcohols, esters, ethers, amides and amines. In yet other contemplated embodiments, the solvent or solvent mixture may comprise a combination of any of the solvents mentioned herein. Contemplated solvents may also comprise aprotic solvents, for example, cyclic ketones such as cyclopentanone, cyclohexanone, cycloheptanone, and cyclooctanone; cyclic amides such as N-alkylpyrrolidinone, wherein the alkyl has from about 1 to 4 carbon atoms; N-cyclohexylpyrrolidinone and mixtures thereof.

Other organic solvents may be used herein insofar as they are able to aid dissolution of an adhesion promoter (if used) and at the same time effectively control the viscosity of the resulting solution as a coating solution. It is contemplated that various methods such as stirring and/or heating may be used to aid in the dissolution. Other suitable so vents include methyethylketone, methylisobutylketone, dibutyl ether, cyclic dimethylpolysiloxanes, butyrolactone, γ-butyrolactone, 2-heptanone, ethyl 3-ethoxypropionate, 1-methyl-2-pyrrolidinone, propylene glycol methyl ether acetate (PGMEA), hydrocarbon solvents, such as mesitylene, xylenes, benzene, toluene di-n-butyl ether, anisole, acetone, 3-pentanone, 2-heptanone, ethyl acetate, n-propyl acetate, n-butyl acetate, ethyl lactate, ethanol, 2-propanol, dimethyl acetamide, propylene glycol methyl ether acetate, and/or combinations thereof. It is contemplated and preferred that the solvent does not react with the silicon-containing monomer or pre-polymer component.

At least one solvent may be present in compositions and coatings contemplated herein in any suitable amount. In some embodiments, the at least one solvent may be present in an amount of less than about 95% by weight of the overall composition. In other embodiments, the at least one solvent may be present in an amount less than about 75% by weight of the overall composition. In yet other embodiments, the at least one solvent may be present in an amount of less than about 60% by weight of the overall composition. In another contemplated embodiment, the at least one solvent may be present in an amount from about 10% to about 95% by weight of the overall composition. In yet another contemplated embodiment, the at least one solvent may be present in an amount from about 20% to about 75% by weight of the overall composition. In other contemplated embodiments, the at least one solvent may be present in an amount from about 20% to about 60% by weight of the overall composition. It should be understood that the greater the percentage of solvent utilized, the thinner the resulting film.

The compositions and coatings contemplated herein may also comprise additional components such as at least one polymerization inhibitor, at least one light stabilizer, at least one adhesion promoter, at least one antifoam agent, at least one detergent, at least one flame retardant, at least one pigment, at least one plasticizer, at least one surfactant or a combination thereof. In some embodiments, contemplated compositions and coatings may further comprise phosphorus and/or boron doping. In those embodiments that comprise phosphorus and/or boron, these components are present in an amount of less than about 10% by weight of the composition. In other embodiments, these components are present in an amount ranging from about 10 parts per million to 10% by weight of the composition.

The solutions may also be laid down in a continuous film, which is patterned later, or a film that is selectively patterned. As contemplated herein, applying the solutions to a substrate to form a thin layer comprises any suitable method, such as spin-coating, slit-coating, cast-coating, Meyer rod coated, dip coating, brushing, rolling, spraying, and/or inkjet printing. Prior to application of the photosensitive compositions, the surface or substrate can be prepared for coating by standard and suitable cleaning methods. The solution is then applied and processed to achieve the desired type and consistency of coating. Although the general method is outlined above, it should be understood that these steps can be tailored for the selected transparent conductive material and the desired final product.

The term “substrate”, as used herein, includes any suitable surface where the compounds and/or compositions described herein are applied and/or formed. For example, a substrate may be a silicon wafer suitable for producing an integrated circuit, and contemplated materials are applied onto the substrate by conventional methods. In another example, the substrate may comprise not only a silicon wafer but other layers that are designed to lie under the contemplated photosensitive compositions.

Suitable substrates include films, glass, ceramic, plastic, metal, paper, composite materials, silicon and compositions containing silicon such as crystalline silicon, polysilicon, amorphous silicon, epitaxial silicon, silicon dioxide (“SiO₂”), silicon nitride, silicon oxide, silicon oxycarbide, silicon carbide, silicon oxynitride, organosiloxanes, organosilicon glass, fluorinated silicon glass, indium tin oxide (ITO) glass, ITO coated plastic, and semiconductor materials such as gallium arsenide (“GaAs”), and mixtures thereof. In other embodiments, suitable substrates comprise at least one material common in the packaging and circuit board industries such as silicon, glass and polymers, A circuit board made of the compositions described herein may comprise surface patterns for various electrical conductor circuits. The circuit board may a so include various reinforcements, such as woven non-conducting fibers or glass cloth. Contemplated circuit boards may also be single sided or double sided.

The surface or substrate may comprise an optional pattern of raised lines, such as oxide, nitride, oxynitride, or metal lines which are formed by well known lithographic techniques Suitable materials for the lines include silicon oxide, silicon nitride, silicon oxynitride, ITO, aluminum, copper, silver, chromium, tantalum, titanium, cobalt, nickel, gold, tungsten, or the combination thereof. Other optional features of the surface of a suitable substrate include an oxide layer, such as an oxide layer formed by heating a silicon wafer in air, or more preferably, an SiO₂ oxide layer formed by chemical vapor deposition of such art-recognized materials as, e.g., plasma-enhanced tetraethoxysilane oxide (“PETEOS”), plasma enhanced silane oxide (“PE silane”) and combinations thereof, as well as one or more previously formed silica dielectric films.

Once the transparent conductive material is utilized to form a layer or an article, it can be overcoated with at least one low refractive index material for light extraction. Suitable low refractive index materials include DuPont TEFLON AF, Honeywell's AccuOpto-T and NANOGLASS, acrylic coatings and sealers along with other suitable materials.

Methods of forming patterned transparent conductive coatings include: a) providing and applying a layer comprising at least one photosensitive or photoimageable composition to a surface; b) providing and applying the transparent conductive materials disclosed to the previously applied layer, and c) exposing and developing the layered material to form a patterned transparent conductive coating. In other embodiments, methods of forming patterned transparent conductive coatings include: a) providing and applying the transparent conductive materials disclosed to a surface; b) providing and applying a layer comprising at least one photosensitive or photoimageable composition to the previously applied layer, and c) exposing and developing the layered material to form a patterned transparent conductive coating. In yet other embodiments methods of forming a patterned transparent conductive coating include: a) providing and applying a layer comprising materials disclosed, and exposing and developing the layer to form a patterned transparent conductive coating. The various layers may be applied in a pattern by suitable printing techniques such as ink jet, gravure, etc.

In some embodiments, the transparent conductive material is treated with or by a performance enhancement step before being utilized, Suitable performance enhancement or “finishing” steps include a general alkaline treatment, including treatment with strong bases. Contemplated strong bases include hydroxide constituents, such as a treatment by sodium hydroxide. Other hydroxides which may be useful include lithium hydroxide, potassium hydroxide, or ammonium hydroxide, calcium hydroxide, or magnesium hydroxide. Alkaline treatment can be at pH greater than 7, more specifically at pH greater than 10 In some instances, these finishing steps result in materials that have improved transparency and conductivity. It is believed that one reason that the performance of the materials is improved is that the finishing steps remove or otherwise degrade any nonconductive coating layers (such as a polymer coating) which may be on the conductive materials thus removing a material that can affect both transparency and conductivity. This type of finishing step or treatment can be done during formulation of the transparent conductive material or after film is laid down. For example, in the case of conductive nanowires, an alkaline constituent may be added to the composition before it is laid down in a coating or layer. While not being bound by theory, this observation is non obvious and counter to the teachings of Alden (US 2007/0074316. Alden specifically teaches that the use of a metal reducing agents can be used as a post-treatment to improve transparent conductor performance. That is, the transparent conductor can be exposed to a chemical that causes silver oxide to be reduced to silver by a reaction such as the following reaction:

2Ag₂O+NaBH₄+4H20=4Ag₍ₘ₎+4H₂O+NaB(OH)₄

In half reactions:

2Ag₂O=4Ag⁺=4O⁼

4Ag⁺+8e⁻=4Ag

NaBH₄+4H2O=8e⁻+8H⁺+NaB(OH)₄

4O⁼+8H⁺=4H₂O

Furthermore, it is known that simple hydroxides do not reduce silver oxide to silver, but rather oxidize silver to silver oxide as follows:

Ag₍ₘ₎+M⁺OH⁻+H⁺_{(aq)}=Ag⁺OH⁻+M⁺+e⁻+½H2_{(g)}

However, in spite of the fact that hydroxides are not considered as reducing agents, it has been discovered that hydroxide treatment—when applied to conductive nanowire coatings—are beneficial to increasing the conductivity and transparency performance of nanowire-based coatings.

One reason for this phenomenon may be that a small but useful amount of oxide is formed on the surface of the conductive species, which beneficially modifies the optical properties and conductivity of the conductive nanowire network, by forming an oxide film of favorable thickness on top of the conductive nanowire. Another explanation for the improved performance may be that contact between the conductive nanowires is improved as a result of the treatment, and thereby the overall conductivity of the nanowire network is improved, Oxide scale formation may result in a overall expansion of the dimensions of the nanowire, and if the nanowires are otherwise held in a fixed position may result in a greater nanowire-to-nanowire contact. Another mechanism by which the conductivity could improve is via the removal of any residual coating or surface functional groups that were formed or placed on the nanowires during either nanowire synthesis or during formation of the conductive coating. For example, the alkaline treatment may remove or reposition micelles or surfactant coatings that are used to allow a stable nanowire dispersion as an intermediate process in forming the conductive nanowire coatings. Example 2C shows how properties of these transparent conductive materials can be improved with a suitable finishing step.

### EXAMPLES

### Example 1

### Preparation of Silver Nanowire Coating

Poly vinyl pyrrolidone (PVP)-capped silver nanowires (AgNW) were prepared according to the methods described in Chem. Mater. 2002, 14, 4736, by Sun, et al. 20 mg of PVP-capped silver nanowires were placed in 20 ml vial. 10 ml isopropyl alcohol (IPA) was added to the same bottle, and the bottle was sonicated in an ultrasonic bath for 15 min to get a AgNW suspension. Glass and PET substrates were placed on hot plates with the temperature at 50-70° C., the AgNW suspension was air brushed sprayed onto the substrate to get a conductive coating (airbrushing of nanomaterials is known in the prior art, for example, Kaempgen, et al., Synthetic Metals 135-136 (2003), 755-756). Air brush coating thickness can be varied to achieve surface resistivity between 6 ohm/sq and 160 ohm/sq, and transmittance between 35% and 70%.

### Example 2

### Preparation of Films Containing Silver Nanowires on Glass

### Example 2A

PVP-capped silver nanowires (AgNW) were prepared according to the methods described in Chem. Mater. 2002, 14, 4736, by Sun, et al. 0.1706 g of the AgNW were placed in a 20 mL flask equipped with a stir bar. 10 mL of bromopropane (Aldrich [106-94-5] 99%) was added to the flask. Five drops of dodecanethiol (Aldrich ([112-55-0] 98+%) were then added to the flask. The flask was capped and allowed to stir for several hours. The solution was then air-brushed onto a microscope glass slide until there was a noticeable change in transparency. The coating was applied with several passes of the air brush. The glass substrate was held on a hot plate that was maintained at 60-70° C.

As deposited, the films showed no electrical conductivity as measured with a digital multimeter (Note: electrical conductivity and electrical resistivity are inverse quantities. Very low electrical conductivity, corresponds to very high electrical resistivity. No electrical conductivity refers to electrical resistivity that is above the limits of the measurement equipment available. The measurement equipment used for this example was capable of measuring resistivities of at least 1E9Ω/sq). The films were then baked in an oven at 90-100° C. for 2-3 hours. The films were again measured for electrical resistivity. Acceptable electrical resistivity was measured, along with sufficient optical transmission. The resistivity was 10-50Ω/sq when measured using a commercially available surface resistivity meter. The transparency was at least 85% when measured using a commercially available haze meter (available from BYK Gardner).

### Example 2B

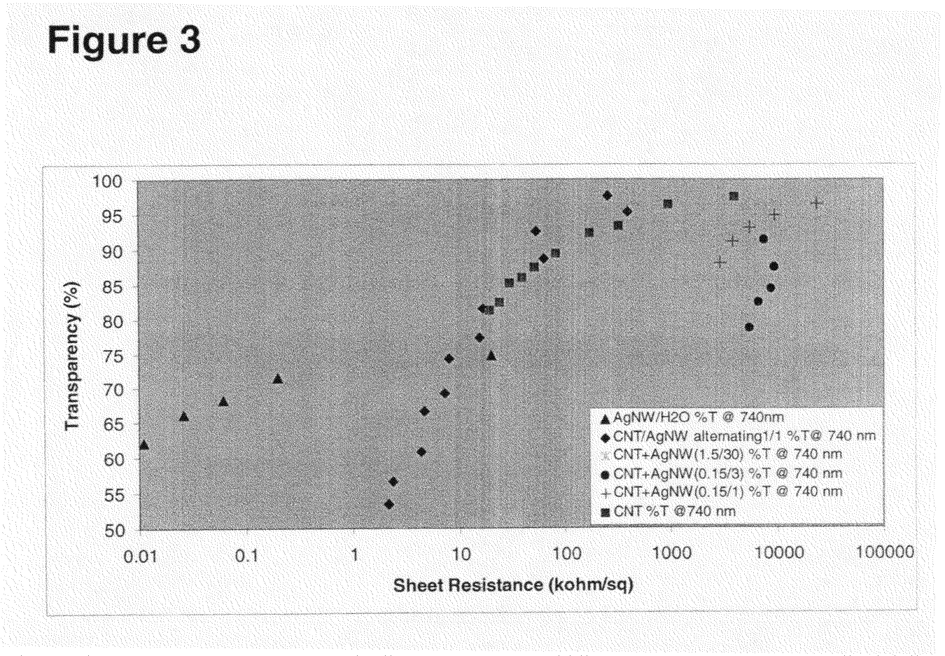

PVP-capped silver nanowires (AgNW) were prepared according to the methods described in Chem. Mater. 2002, 14, 4736, by Sun, et al. An aqueous suspension containing approximately 30 mg AgNW in 10 ml water was prepared. The solution was then air-brushed onto a microscope glass slide until there was a noticeable change in transparency. The coating was applied with several passes of the air brush. The glass substrate was held on a hot plate that was maintained at approximately 100° C., Similarly suspensions containing a) approximately 30 mg AgNW in 10 ml isopropanol and b) approximately 30 mg AgNW in 10 ml ethylene glycol were prepared. FIG. 3 shows transparency data versus sheet resistance for the performance of AgNW coatings on glass. The conductivity of the isopropanol based coating was approximately 600 ohms per square at 65% transmission using 740 nm light, and the conductivity of the isopropanol based coating was approximately 100,000 ohms per square at 77% transmission.

### Example 2C

Silver dendrites and nanowires can be prepared utilizing a synthesis similar to that described in K. Peng, J, Zhu, Electrochemica Acta, 49 (2004) pp. 2563-2568.

0.02 M AgNO₃ and 4.6 M HF was prepared using the following: 0.3397 g AgNO₃ (99+% ACS Reagent [7761-88-8]) was weighed in a 125 mL bottle. 16.3 mL of 49% HF was added to the same bottle. The volume was then brought up to 100 mL with deionized water. The solution was then transferred to a plastic beaker and allowed to equilibrate to 60° C. Pieces of silicon (˜2 cm×2 cm) were placed in the solution and allowed to react for 1 hour. The AgNW were then rinsed, filtered and dried. AgNW can also be prepared utilizing 0.04 M AgNO₃, 0.06 M AgNO₃ and 0.08 M AgNO₃.

0.1079 g of AgNW/dendrites were weighed and placed into an air brush glass bottle. 15 mL of reagent grade acetone was added to the bottle, along with 2 drops of dodecanethiol. The solution was allowed to stir for 5 hours prior to spraying. The solution was then air-brushed onto a microscope glass slide until there was a noticeable change in transparency. The coating was applied with several passes of the air brush. The glass substrate was held on a hot plate that was maintained at 60-70° C.

The surface resistivity was about 50 to 100Ω/sq when measured using a commercially available surface resistivity meter. The transparency was at least about 85% when measured using a commercially available haze meter.

### Example 2D

Silver nanowires, as described in Chem. Mater. 2002, 14, 4736, by Sun, et al., were also blended with carbon nanotubes, coated on substrates and analyzed with respect to transparency and sheet resistance. FIG. 3 shows representative data. Transparency was measured at 740 nm.

In the first data set_(AgNW/H₂O % T@740 nm), A suspension consisting of silver nanowires (30 mg) and 10 mL of water (H₂O) was laid down as a film and analyzed.

In the next data set (CNT/AgNW alternating 1/1% T@740 nm), a suspension comprising carbon nanotubes (1 mg CNT, 15 mg CASS (cholic acid sodium salt available from EMD biosciences) and 7 mL H2O) was laid down in an alternating fashion with a suspension of AgNW (30 mg AgNW with 10 mL H₂O). The CNT was purchased from SouthWest NanoTechnologies, Inc. 1 mg CNT was added to 7 ml CASS/H2O (15 mg/7 ml) and sonicated with an ultrasonic probe for 20 min to get a uniform CNT/CASS/H2O suspension. CNT/CASS/H2O and AgNW/H2O suspensions were coated alternatively on the substrate to form multi-layers. The layers are treated with water before analysis.

In the next data set (CNT+AgNW (1.5/30) % T@740 nm), the suspension combined 1.5 mg CNT, 30 mg AgNW and 10 mL H₂O, The layer was then treated with deionized (DI) water before analyzing.

In the next data set (CNT+AgNW (0.15/3) % T@740 nm), the suspension combined 0.15 mg CNT, 3 mg AgNW and 10 ml H₂O, The layer was then treated with DI water before analyzing.

In the next data set (CNT+AgNW (0.15/1) % T@740 nm), the suspension combined 0.15 mg CNT, 1 mg AgNW and 10 ml H₂O, The layer was then treated with water before analyzing. In the last data set (CNT % T@740 nm), a suspension comprising carbon nanotubes (1 mg CNT, 15 mg CASS and 7 ml H2O) is laid down on the substrate, the layer was treated with DI water before analyzing.

### Example 2E

It was also shown that NaOH/H₂O treatment improves the performance of AgNW coatings. PVP-capped silver nanowires (AgNW) were prepared according to the methods described in Chem. Mater. 2002, 14, 4736, by Sun, et al. An aqueous suspension containing approximately 30 mg AgNW in 10 ml water was prepared. The solution was then air-brushed with several passes of the air brush onto a microscope glass slide until there was a noticeable change in transparency. The glass substrate was held on a hot plate that was maintained at approximately 100° C. until dry. At this point and before any NaOH treatment, the sheet resistance was measured at 125Ω/sq and 67.0% T.

The sample was then treated in an aqueous NaOH, and subsequently rinsed and dried by forced air drying. After treatment, the sheet resistance was measured at 86.2Ω/sq and 71.4% T. A suitable concentration for the aqueous NaOH is 1 Mole/liter. A suitable exposure is 1 minute.

### Example 3

### Silver Nanowires Coated on Flexible Pet Substrate

PVP-capped silver nanowires (AgNW) were prepared according to the methods described in Chem. Mater. 2002, 14, 4736, by Sun, et al. 0.4391 g of AgNWs were dispersed in 15 mL of propylene carbonate (PC) and allowed to stir for 2 hours. The viscous fluid was able to disperse the silver nanowires better than the more volatile solvents, such as bromopropane, acetone, IPA, etc. The mixture was then airbrushed onto PET substrates that were maintained at about 65° C. The films were deposited with multiple coats onto the substrates. The PET substrate was folded in half and the resistance was measured. The resistance fluctuated around 3000Ω.

### Example 4

### Nanowires+Photoimageable Composition, Patterned

In the current example, metal nanowires—specifically silver nanowires—were utilized in combination with a photoimageable composition to form a patternable layer of transparent conductive material. The photoimageable composition was made from TEOS, AcTMOS, IPA and PGMEA. The monomer ratio was TEOS:AcTMOS of 1:1 in a one-step reaction, as described in PCT Application Serial No.: PCT/CN2006/001351, as mentioned earlier. A photoimageable composition with different solid contents, 15%-to-30%, could be used to produce the patternable transparent conductive layer. Table 1 provides some typical properties and characteristics for these layered materials.

In this specific example, a layer of the photoimageable composition was spin-coated onto the silicon wafer and glass substrate at a thickness of 1.2 μm. Specifically, 2 mL of the photoimageable composition is statically dispensed on a 4″ wafer, and then spun at 900 RPM for 2 seconds followed by spinning at 1500 RPM for 50 seconds. The coated wafer was placed on hot plate with the temperature at 50-70° C. A suspension of PVP-capped si ver nanowires (AgNW) (prepared by adding 20 mg AgNW powder (per Chem. Mater. 2002, 14, 4736, by Sun, et al) into 10 mL isopropyl alcohol, followed by 15 minutes of sonication with a sonication bath) was sprayed on the layered wafer by method shown in Example 1. The surface resistivity of the resulting coating was 6 ohm/sq at the transmittance of 35.3%.

The coated wafer was place in a UV box, exposed under UV light with energy of 50 mJ/cm2 by using a photo mask. The wafer was then developed with 2.38% TMAH for 60 seconds under static condition to remove the un-exposed area; after rinsing with Dl water a clean patterned coating was then obtained on the wafer. The coating was dried under N2 purge. The SR of the patterned AgNW was 6 ohm/sq at the transmittance of 35.6%.

A photo mask was used for the patterning. The patterns can be of any shape depending on the mask design, the narrowest line width can be as small as 100 um.

Thus, specific embodiments and applications of photosensitive materials and their uses thereof have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A transparent conductive material, comprising:
at least one conductive component, and
at least one photoimageable or photosensitive material, wherein the at least one conductive component and the at least one photoimageable or photosensitive material are coupled to form the transparent conductive material.

2. The transparent conductive material of claim 1, wherein the transparent material has a percent transmittance of at least 50%.

3. The transparent conductive material of claim 2, wherein the transparent material has a percent transmittance of at least 70%.

4. The transparent conductive material of claim 3, wherein the transparent material has a percent transmittance of at least 90%.

5. The transparent conductive material of claim 1, wherein the at least one conductive component comprises discrete conductive structures, conductive nanowires, conductive nanoparticles, conductive nanotubes, conducting polymers and composites, or combinations thereof.

6. The transparent conductive material of claim 1, wherein the at least one conductive component comprises a metal, a metal oxide, a polymer, an alloy, a composite, carbon or combinations thereof.

7. The transparent conductive material of claim 5, wherein the at least one conductive component comprises conductive nanotubes.

8. The transparent conductive material of claim 7, wherein the conductive nanotubes comprise carbon.

9. The transparent conductive material of claim 5, wherein the at least one conductive component comprises conductive nanowires.

10. The transparent conductive material of claim 9, wherein the conductive nanowires comprise silver.

11. The transparent conductive material of claim 1, wherein the at least one photoimageable or photosensitive material comprises diazonaphthoquinone (DNQ), photoacid generators (PAG), photobase generators (PBG), polymeric or monomeric-based photoimageable materials or combinations thereof.

12. The transparent conductive material of claim 1, further comprising a hydroxide constituent.

13. The transparent conductive material of claim 12, wherein the hydroxide constituent comprises sodium hydroxide, lithium hydroxide, potassium hydroxide, ammonium hydroxide, calcium hydroxide, magnesium hydroxide or a combination thereof.

14. The transparent conductive material of claim 1, wherein the at least one conductive component and the at least one photoimageable or photosensitive material are coupled to form the transparent conductive material by grafting or attaching the at least one photoimageable or photosensitive material to the at least one conductive component.

15. The transparent conductive material of claim 1, wherein the at least one conductive component and the at least one photoimageable or photosensitive material are coupled to form the transparent conductive material by blending the at least one photoimageable or photosensitive material with the at least one conductive component.

16. The transparent conductive material of claim 1, wherein the at least one conductive component and the at least one photoimageable or photosensitive material are coupled to form the transparent conductive material by layering the at least one photoimageable or photosensitive material on top of at least part of the at least one conductive component.

17. The transparent conductive material of claim 1, wherein the at least one conductive component and the at least one photoimageable or photosensitive material are coupled to form the transparent conductive material by layering the at least one photoimageable or photosensitive material under at least part of the at least one conductive component.

18. A patterned transparent conductive coating comprising the transparent conductive material of claim 1.

19. A transparent conductive material, comprising a plurality of conductive nanowires and an alkaline constituent.

20. The transparent conductive material of claim 19, wherein the transparent material has a percent transmittance of at least 90%.

21. The transparent conductive material of claim 19, wherein the conductive material comprises at least one additional conductive component that comprises discrete conductive structures, conductive nanoparticles, conductive nanotubes, conducting polymers and composites, or combinations thereof.

22. The transparent conductive material of claim 19, wherein the plurality of conductive nanowires comprises a metal, a metal oxide, a polymer, an alloy, a composite, carbon or combinations thereof.

23. The transparent conductive material of claim 22, wherein the plurality of conductive nanowires comprise silver.

24. The transparent conductive material of claim 19, wherein the conductive material further comprises a plurality of conductive nanotubes.

25. The transparent conductive material of claim 19, wherein the alkaline component comprise a hydroxide constituent.

26. The transparent conductive material of claim 25, wherein the hydroxide constituent comprises sodium hydroxide, lithium hydroxide, potassium hydroxide, ammonium hydroxide, calcium hydroxide, magnesium hydroxide or a combination thereof.

27. A transparent conductive material comprising a conductive material, wherein the conductive material comprises at least two of the following components: discrete conductive structures, conductive nanowires, conductive nanoparticles, conductive nanotubes, conducting polymers and composites, or combinations thereof.

28. The transparent conductive material of claim 27, wherein the conductive nanowires comprises a metal, a metal oxide, a polymer, an alloy, a composite, carbon or combinations thereof.

29. The transparent conductive material of claim 27, further comprising a hydroxide constituent.

30. The transparent conductive material of claim 29, wherein the hydroxide constituent comprises sodium hydroxide, lithium hydroxide, potassium hydroxide, ammonium hydroxide, calcium hydroxide, magnesium hydroxide or a combination thereof.

31. A method of forming a patterned transparent conductive coating, comprising:
providing and applying a layer comprising at least one photosensitive or photoimageable composition to a surface;
providing and applying the transparent conductive material of one of claims 19 or 27 to the previously applied layer, and
exposing and developing the layered material to form a patterned transparent conductive coating.

32. The method of claim 31, wherein the method further comprises treating the patterned transparent conductive coating with a finishing step.

33. The method of claim 32, wherein the finishing step comprises an alkaline treatment.

34. The method of claim 33, wherein the alkaline treatment includes treatment with sodium hydroxide, lithium hydroxide, potassium hydroxide, ammonium hydroxide, calcium hydroxide, magnesium hydroxide or a combination thereof.

35. A method of forming a patterned transparent conductive coating, comprising:
providing and applying the transparent conductive material of one of claims 19 or 27 to a surface;
providing and applying a layer comprising at least one photosensitive or photoimageable composition to the previously applied layer, and
exposing and developing the layered material to form a patterned transparent conductive coating.

36. The method of claim 35, wherein the method further comprises treating the patterned transparent conductive coating with a finishing step.

37. The method of claim 36, wherein the finishing step comprises an alkaline treatment.

38. The method of claim 37, wherein the alkaline treatment includes treatment with sodium hydroxide, lithium hydroxide, potassium hydroxide, ammonium hydroxide, calcium hydroxide, magnesium hydroxide or a combination thereof.

39. A method of forming a patterned transparent conductive coating, comprising:
providing and applying a layer comprising the material of claim 1, and
exposing and developing the layer to form a patterned transparent conductive coating.

40. The method of claim 39, wherein the method further comprises treating the patterned transparent conductive coating with a finishing step.

41. The method of claim 40, wherein the finishing step comprises an alkaline treatment.

42. The method of claim 41, wherein the alkaline treatment includes treatment with sodium hydroxide, lithium hydroxide, potassium hydroxide, ammonium hydroxide, calcium hydroxide, magnesium hydroxide or a combination thereof.

43. A conductive element or structure comprising the transparent conductive material of claim 19.

44. A conductive element or structure made from the transparent conductive material of claim 27.

45. A conductive element or structure comprising the patterned transparent conductive material of claim 18.
